(19) United States
(12) Patent Application Publication
(10) Pub. No.: US 2013/0214714 A1
(43) Pub. Date: Aug. 22, 2013

(54) METHOD AND DEVICE FOR CONTROLLING A SYNCHRONOUS MACHINE

(71) Applicant: Martin Eisenhardt, Renningen (DE)

(72) Inventor: Martin Eisenhardt, Renningen (DE)

(21) Appl. No.: 13/818,900

(22) PCT Filed: Jul. 20, 2011
(86) PCT No.: PCT/EP11/62412

§ 371 Date: May 3, 2013

(30) Foreign Application Priority Data
Aug. 25, 2010 (DE) 10 2010 039 766.0

(51) Int. Cl. H02P 6/00

(52) U.S. Cl. CPC H02P 6/001
USPC 318/400.21

(57) ABSTRACT

In a method for controlling a synchronous machine having a stator, a rotor, and magnets situated on the rotor, first a nominal value is set for the magnetic flux prevailing in the synchronous machine, and a marker is set in a control unit that indicates that no calibration has yet been carried out. It is then checked repeatedly whether the synchronous machine has been out of operation for at least a specified time duration. If this is the case, a temperature balance between the stator and the rotor is assumed, so that the temperature to be measured at the stator is equal to the rotor temperature, and thus can be used as a basis for a calibration of the magnetic flux. A marker that indicates the carrying out of a flux calibration is set in the control unit. Subsequently, normal operation can be continued.

### BACKGROUND OF THE INVENTION

1. Field of the Invention

The present invention relates to a method for controlling a synchronous machine, and to a corresponding device for controlling a synchronous machine.

2. Description of the Related Art

Permanently excited synchronous machines are often used today in electrical drives for hybrid and electric vehicles. Such a synchronous machine has a rotor in which there are standardly situated magnets that produce a magnetic flux, and has a stator having stator windings. The synchronous machine can produce a torque that is a function in particular of a phase current and of a magnetic flux in the machine. The produced torque can determine the acceleration or driving behavior of the vehicle, and can thus represent an important quantity that is to be determined during driving operation.

The magnets in the rotor can be relatively sensitive to temperature, and can be permanently damaged at temperatures that may in some circumstances be reached already during normal driving operation of the vehicle. In order to prevent such damage, the phase currents are standardly limited once a critical magnet temperature has been reached.

Because the rotor is in most cases a rapidly rotating component, the temperature of the magnets situated thereon can be measured directly, though at high expense. Standardly, a temperature sensor is not provided on the rotor. Instead, the temperature of the magnets is conventionally estimated from the measured temperature of the stator. In this estimation of the magnet temperature, it is assumed that the rotor and the permanent magnets have approximately the same temperature as the stator. However, this estimate is often subject to significant error, particularly during transient processes.

In order to make it possible to maintain a sufficiently large safety distance from a maximum permissible magnet temperature, the temperature threshold for the above-named limitation of the phase current must be chosen to be relatively low, with the result that the maximum output of the synchronous machine cannot be completely exploited.

Published German patent application document DE 10 2005 062 588 describes a method for determining the magnet temperature of a permanently excited electric machine. Here, the magnet temperature can be determined by measuring a phase voltage and a rotational speed of the electric machine.

For the calculation of a torque, and for the calculation of a rotor temperature, a precise knowledge of the magnetic flux may be required. In previously known solutions, for this purpose the magnetic flux can be calibrated once following the manufacture of the synchronous machine or after a maintenance service of the synchronous machine, or of the pulse inverter required for the controlling of the synchronous machine. During such a calibration, a characteristic map can be produced that can be stored in a control unit of the synchronous machine and that can indicate a relation between rotor temperature T and the phase voltage U_{ind} that is to be measured, and rotational speed n that is to be measured.

After such a calibration, and the production connected therewith of the characteristic map, rotor temperature T can later be inferred by measuring phase voltage U_{ind} and rotational speed n, and from this rotor temperature it is then in turn possible to determine the magnetic flux, which is a function of the rotor temperature.

For a calibration of the magnetic flux, the temperature of the magnets situated on the rotor must be known, so that errors due to temperature influences can be minimized. Since, however, in synchronous machines it is typically the case that no temperature sensor is provided directly on the rotor, but rather a temperature sensor is present only on the stator, conventionally the rotor temperature is inferred from the stator temperature, and from this the temperature of the magnets is inferred. Here it is assumed that an input of heat into the rotor takes place only if the stator is also significantly heated during the operation of the synchronous machine. It is further assumed that the rotor temperature is equal to the stator temperature when the stator falls below a particular temperature threshold. Only then is a calibration of the magnetic flux carried out.

A disadvantage here can be that a relatively low temperature threshold, with regard to the temperature measured at the stator, has to be fallen below before a calibration can be carried out. This can be a problem in particular in countries having a hot climate.

### BRIEF SUMMARY OF THE INVENTION

It is therefore sought to be able to carry out a calibration of the magnetic flux for synchronous machines in a reliable manner, as independently as possible of a temperature prevailing in the surrounding environment, i.e. in particular also in the case of higher ambient temperatures, in order to be able to control the synchronous machine as well as possible over its entire range of output.

The machine that is to be controlled can be a permanently excited synchronous machine having a stator, a rotor, and a plurality of magnets situated on the rotor, preferably in the form of permanent magnets. The synchronous machine is for example controlled using a pulse inverter in such a way that, based on an assumed or previously determined value of the magnetic flux produced by the magnet, a desired torque is produced by the synchronous machine. In order to make it possible to carry out a controlling of the synchronous machine in as precise a manner as possible, a magnetic flux produced by the magnets is calibrated based on a temperature measured at the stator, as soon as this is reliably possible. According to the present invention, this calibration is not carried out until the synchronous machine has been out of operation for at least a specified time duration t_{g}.

In other words, a calibration of the magnetic flux is not carried out until for example a downtime tₐ that has elapsed since the last operation of the synchronous machine is greater than a minimum time duration t_{g} (i.e., tₐ>t_{g}). Information concerning such a downtime is typically always available in hybrid vehicles, and is often made available to other control devices in the system of control devices in the vehicle by a central control device using a data bus provided in a vehicle, also called a Controller Area Network (CAN), via a CAN message.

The calibration of the magnetic flux is not carried out until a sufficiently long downtime has elapsed.

The minimum downtime that is to be reached, i.e., the specified time duration t_{g} during which the synchronous machine has no longer been operated since its last operation, can correspond to a time duration that is required to reach a temperature balance between the stator and the rotor. After this time duration, it can be assumed that the temperature of all components in the synchronous machine has become equal, and the rotor temperature is therefore equal to the stator temperature.

During the controlling of the synchronous machine it can be advantageous to note whether a calibration has already been carried out or not. For this purpose, before the calibration a marker can be set in a control unit of the synchronous machine that indicates that the magnetic flux used as a basis for the controlling of the synchronous machine corresponds to a nominal value, i.e., that it does not yet correspond to the measurable magnetic conditions actually prevailing in the synchronous machine. After the calibration, a marker can be set in the control unit of the synchronous machine that indicates that the magnetic flux used as a basis in the controlling of the synchronous machine corresponds to the calibrated flux value. On the basis of the stored markers, the controlling of the synchronous machine can detect how precisely and reliably a value can be determined for the rotor temperature. Before a calibration can be carried out, only a nominal value can be assumed in such a determination, so that the temperature determination may be subject to high possible error, requiring that corresponding safety measures be taken during the operation of the synchronous machine. After calibration has taken place, the rotor temperature can then be determined more reliably. Therefore, after such a calibration the synchronous machine can be precisely controlled over larger areas of its power spectrum.

The calibration of the magnetic flux can be carried out independent of the temperature actually prevailing in the synchronous machine. While in conventional control methods a calibration took place only when the temperature measured at the stator of the synchronous machine was below a specified maximum value, it is now possible, independent of the actually prevailing temperature in the synchronous machine, to carry out a calibration of the magnetic flux whenever the synchronous machine has been idle for a sufficiently long period of time and a temperature balance between the stator and the rotor can therefore be assumed. In the calibration, it is then possible to assume, even at high stator temperatures, that the rotor, or the magnets, are at the same temperature as the stator, and that this temperature can be reliably measured and used as a basis for the calibration.

The calibration need be carried out only once after the manufacture of the synchronous machine or after a maintenance of the synchronous machine. After a characteristic map, or characteristic curve, for the functional relationship between the magnetic flux and the rotor temperature has once been determined with the aid of the calibration, these can be used during the later controlling of the synchronous machine in order to achieve a reliable, efficient operation.

It is to be noted that ideas concerning the present invention are described herein in connection both with the method and with the device for controlling a synchronous machine, as well as with reference to a vehicle provided with such a device. It will be clear to someone skilled in the art that the individual features described can be combined with one another in various ways in order to additionally arrive at further embodiments of the present invention.

Specific embodiments of the present invention are described in the following with reference to the accompanying drawings.

### BRIEF DESCRIPTION OF THE DRAWINGS

FIG. 1 shows a schematic representation of a permanently excited synchronous machine that can be controlled according to a specific embodiment of the present invention.

FIG. 2 shows a flow diagram illustrating a control process of a synchronous machine according to a specific embodiment of the present invention.

### DETAILED DESCRIPTION OF THE INVENTION

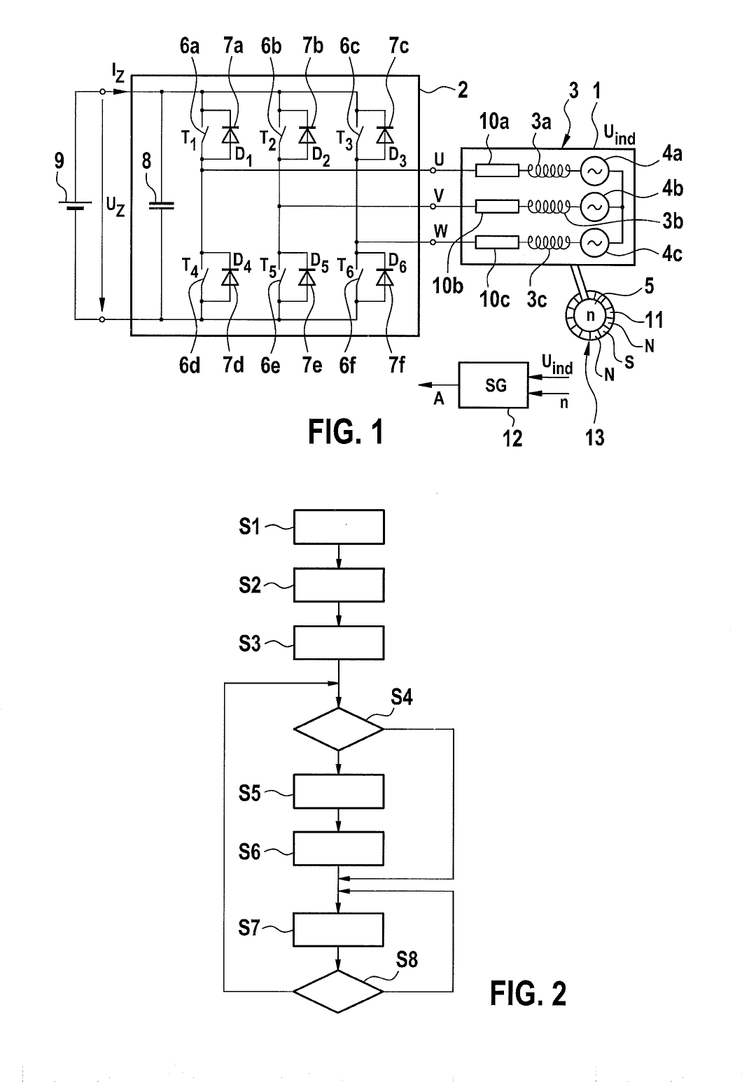

FIG. 1 shows a schematic representation of a permanently excited synchronous machine 1 having a pulse inverter (PWR) 2. PWR 2 determines the output and mode of operation of synchronous machine 1, and is correspondingly controlled by a control device 12. In this way, synchronous machine 1 can be operated optionally in engine operation or in generator operation. In engine operation, the synchronous machine produces a drive moment that can for example support an internal combustion engine during an acceleration phase of a vehicle. In contrast, in generator operation mechanical energy is converted into electrical energy, and is stored for example in an energy storage device 9 such as a battery or a supercapacitor.

In the depicted Figure, synchronous machine 1 is realized having three phases (phases U, V, W), and has a stator 3 having three lines 3a-3c and a rotor 13 having a plurality of permanent magnets 11. The ohmic resistances of lines 3a-3c are designated 10a-10c. The three phases U, V, W of electric synchronous machine 1 are each connected to pulse inverter 2. PWR 2 has, in a known manner, a plurality of switches 6a-6f with which individual phases U, V, W can optionally be connected to an intermediate circuit potential U_{Z} or to a reference potential (ground). PWR 2 also has a plurality of freewheeling diodes 7a-7f that can each be connected in parallel to one of switches 6a-6f.

In order to determine the temperature of permanent magnets 11 provided on rotor 13, it is possible, as described in more detail below, to make use of a characteristic curve or a characteristic map that can be stored in control device 12. This characteristic curve or characteristic map can be determined during a calibration process. Using the characteristic curve or characteristic map, temperature T of permanent magnets 11 can be determined from magnetic flux ψ, which in turn is a function of induced voltage U_{ind} and rotational speed n of electric synchronous machine 1. The following holds here:

T=f(ψ)=f(n, U_{ind})

Rotational speed n of the electric synchronous machine can be measured using a rotational speed sensor 5. The induced voltage in stator windings 3a-3c is shown schematically in the Figure by voltage sources 4a-4c. As induced voltage U_{ind} for example the voltage between two of the phases, for example U and V, or the voltage between one of phases U, V, W and a reference potential can be measured. In the ideal case, this voltage is sinusoidal and is preferably measured during no-load operation of the machine. In no-load operation, all six power switches 6a-6f of pulse inverter 2 are open.

Voltage and rotational speed signals U_{ind} and n are supplied to control device 12 at an input. With the aid of an algorithm stored in control device 12, and based on the characteristic curve or characteristic map, the signals are processed and from them a current temperature T of permanent magnets 11 is determined. If a specified temperature threshold is exceeded, control device 12 produces an output signal A for pulse inverter 2, by which the output of synchronous machine 1 is limited.

In the following, a schema used for the controlling of the synchronous machine, including a calibration carried out during the controlling, is described with reference to the flow diagram shown in FIG. 2.

During a commissioning, for example immediately after the manufacture of the synchronous machine or after a maintenance or service operation on the synchronous machine (step S1), first a nominal value ψₙₑₙₙ of the magnetic flux produced by permanent magnet 11 is set (step S2). Using this preset nominal value ψₙₑₙₙ of the magnetic flux, the synchronous machine can in principle be controlled or regulated. However, this nominal value may not necessarily reflect the magnetic flux actually produced by permanent magnets 11 in the synchronous machine, but rather may indicate only a conservatively assumed value that may have been determined on the basis of previous experience or through simulation or calculation. The actual prevailing magnetic flux is still not known with more precision at this time. The calculation, based on such a nominal value, of the torque and of the temperature of rotor permanent magnets 11 may therefore still be subject to relatively large error.

In a control unit that can for example be realized as software stored in control device 12, it is noted in a suitable manner that a calibration of the magnetic flux has not yet been carried out. For this purpose, a corresponding marker can be set that indicates that the magnetic flux used as a basis in the controlling of the synchronous machine corresponds only to nominal value ψₙₑₙₙ (step S3).

During the subsequent use of the synchronous machine, it is repeatedly checked whether the synchronous machine is currently in operation or not. If for example the vehicle provided with the synchronous machine is currently not in use, i.e. is shut off and at rest, this is recognized by a central control unit of the vehicle and is provided via a CAN message to, inter alia, control device 12 of the synchronous machine. The control unit now checks whether downtime tₐ during which the synchronous machine was not operated is greater than a specified time duration t_{g}, i.e. whether tₐ>t_{g} (step S4).

If this is the case, a calibration of the magnetic flux is carried out (step S5). During this it is assumed that the temperatures inside the synchronous machine have been able to reach an equilibrium due to the long time duration since the shutting off of the synchronous machine, so that temperature T of permanent magnets 11 corresponds to the temperature of the stator. This temperature of the stator can be measured using a temperature sensor situated on the stator and can form the basis of a calibration, i.e., of a production of a characteristic curve or characteristic map. The temperature prevailing in the synchronous machine can be arbitrarily high here. The found magnetic flux ψ_{kalib} is temperature-corrected using the determined rotor temperature.

Subsequently, in the control unit of the synchronous machine a corresponding marker is set that indicates that a calibration of the magnetic flux has been carried out, so that the magnetic flux that is to be used as a basis in the controlling of the synchronous machine corresponds to calibrated flux value ψ_{kalib} (step S6).

If the downtime determined in step S4 is not greater than the specified time duration, i.e. tₐ≦t_{g}, steps S5 and S6 are skipped.

During a subsequent period of normal operation, the synchronous machine can be controlled in such a way that a desired torque is produced based on the magnetic flux taken as a basis (step S7). Depending on whether the magnetic flux has already been calibrated or not, the magnetic flux used as a basis here is either a nominal value ψₙₑₙₙ or the magnetic flux determined during the calibration.

During normal operation, it is repeatedly checked whether a calibration of the magnetic flux has already been carried out (step S8). If this is the case, normal operation is continued unchanged (step S7). If this is not the case, it is checked again whether the downtime is greater than the specified time duration (step S4), and if warranted a calibration of the magnetic flux is carried out.

The described method or described device for controlling a synchronous machine enables an efficient, reliable operation of the synchronous machine. A power spectrum of the synchronous machine can be used over wide ranges even at increased temperatures. A calibration of the magnetic flux can also be carried out even at high temperatures.

The present invention can be used with all permanently excited synchronous machines as are used for example in electric drives of hybrid and electric vehicles.

1-7. (canceled)

8. A method for controlling a synchronous machine having a stator, a rotor, and magnets situated on the rotor, the method comprising:
calibrating a magnetic flux produced by the magnets, based on a temperature measured at the stator; and
controlling the synchronous machine in such a way that, based on the calibrated magnetic flux, a desired torque is produced;
wherein the calibration of the magnetic flux is not carried out until the synchronous machine has been out of operation for at least a specified time duration.

9. The method as recited in claim 8, wherein the specified time duration corresponds to a time duration which is required for a temperature balance between the stator and the rotor.

10. The method as recited in claim 9, further comprising:
setting a first marker in a control unit of the synchronous machine before the calibration of the magnetic flux, wherein the first marker indicates the magnetic flux used as a basis in the controlling of the synchronous machine corresponds to a nominal value; and
setting a second marker in the control unit of the synchronous machine after the calibration of the magnetic flux, wherein the second marker indicates the magnetic flux used as a basis in the controlling of the synchronous machine corresponds to the calibrated flux value.

11. The method as recited in claim 10, wherein the calibration of the magnetic flux is carried out independently of temperature currently prevailing in the synchronous machine.

12. The method as recited in claim 10, wherein the calibration of the magnetic flux is carried out only once after one of the manufacture or a maintenance of the synchronous machine.

13. A control unit for controlling a synchronous machine having a stator, a rotor, and magnets situated on the rotor, comprising:
means for calibrating a magnetic flux produced by the magnets, based on a temperature measured at the stator; and
means for controlling the synchronous machine in such a way that, based on the calibrated magnetic flux, a desired torque is produced;
wherein the calibration of the magnetic flux is not carried out until the synchronous machine has been out of operation for at least a specified time duration.

14. A synchronous machine, comprising:
a stator;
a rotor;
magnets situated on the rotor; and
a control unit including:
means for calibrating a magnetic flux produced by the magnets, based on a temperature measured at the stator; and
means for controlling the synchronous machine in such a way that, based on the calibrated magnetic flux, a desired torque is produced;
wherein the calibration of the magnetic flux is not carried out until the synchronous machine has been out of operation for at least a specified time duration.
